(19) United States
(12) Patent Application Publication
(10) Pub. No.: US 2015/0268830 A1
(43) Pub. Date: Sep. 24, 2015

(54) DISPLAY CONTENT ENABLED MOBILE DEVICE

(71) Applicant: Vladislav Vladislavovich Martynov, Moscow (RU)

(72) Inventor: Vladislav Vladislavovich Martynov, Moscow (RU)

(21) Appl. No.: 14/670,372

(22) Filed: Mar. 26, 2015

Related U.S. Application Data
(63) Continuation of application No. PCT/IB2013/002137, filed on Sep. 26, 2013.

(30) Foreign Application Priority Data
Sep. 26, 2012 (GB) 1217175.7

(51) Int. Cl. G06F 3/0484

(52) U.S. Cl. CPC G06F 3/04845; G06F 3/04847; G06F 3/04842

(57) ABSTRACT

A method implemented by a computer device having a bi-stable screen as a one, and only one, screen for displaying display content associated with an application or service executable on a computer device, the method comprising: receiving the display content; and sending the display content for subsequent display on the bi-stable screen. The display content can be remotely obtained display content such as push notifications messages provided by a remote messaging service over a communications network.

### FIELD

The field of the invention includes displaying of content on mobile devices, in particular message content.

### BACKGROUND

The pervasiveness of computing devices is ever increasing, including both electronic paper device (EPD) types and liquid crystal display (LCD) device type types. For example, users can interact with a traditional desktop computer, a tablet computer, a mobile phone, and so on to access a variety of functionality for work and personal uses. Additionally, the variety of functionality that is available to users of these devices also continues to increase.

However, interaction by a user with local and remote applications, and related display content such as messages (e.g. notifications), can be hindered by the number of applications that are installed on the computing device and the plethora of display content submitted continuously to the display of the computer device. This volume of display content e.g. notifications) can provide a distraction to the user, who must always read the text of each displayed content to determine its relevant to the user at any given moment. Consequently, navigation through these multiply displayed content to locate desired information can take a significant amount of time, which can be further complicated by the number of applications that are available on the computing device and/or remote services/applications that are sending display content (e.g. client-server model) to the computing device over a communications network.

Further, users desire their computer devices to have configurations facilitating reduced power settings and other battery saving techniques. For example, current EPD screen enabled devices do not have the user desired features traditionally provided by more advanced smart phones having LCD screen enabled devices. As such, rate of power consumption is a problem with mobile devices, as battery life is limited between battery charges. Battery power consumption is compounded by the amount of application processing and hardware management implemented on the mobile device for data manipulation. Current EPD screen devices have difficulty in filtering or otherwise interpreting the world around them, including information content (provided to the device remotely and or locally by respective applications or services) displayed on the display of their device.

### SUMMARY

It is an object of the present invention is to provide a display content enabled bi-stable screen device and method to obviate or mitigate at least one of the above-presented disadvantages.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Application notification display techniques and types are described. Implementations are described in which a local application and/or remote application/service send content (e.g. message content such as notifications) that pertain to the application/service for display on the bi-stable screen. Techniques are further described which are be used to manage the display content such as notifications, including replacement of notifications, use of queues, overrides, selection of notifications based on execution state of an application, cycling a display of a plurality of notifications (e.g., by a user or automatically by a local client device), cycling a display of different subsets of notifications, examination of a manifest (e.g. predefined data descriptors and/or predefined display format) of an application to determine criteria to be used to display the notifications, and/or display priority of the notifications, and so on.

Other display content examples for display on the bi-stable screen include display content for: changing the device appearance as context-related content; the context-related device appearance can include location-based advertising; the device appearance can be changed to give an appearance of a different phone case when the bi-stable display screen appears to be part of a device case; the device skin of the device case can be changed as provided by the display content when the bi-stable display screen appears to be part of a device case; and/or the device skin can be changed by the display content to show one or more of wallpaper, photos, movies, or user-customized content when the bi-stable display screen appears to be part of a device case. These display content examples can be performed by the display module using the display content obtained as local content from local application(s)/service(s) and/or using content obtained as remote content from remote application(s)/service(s).

Other display content examples for display on the bi-stable screen can include display content for: display screen output as a social network screen; display screen output as social aggregator output or social network output; display screen output as the social aggregator output or social network output as a Facebook page; display screen output as device location related details provided by a remote server (e.g. triangulation information); display screen output as a Google search page; and display screen output as results of a location-based search. These display content examples can be performed by the display module using the display content obtained as remote content from remote application(s)/service(s).

Other display content examples for display on the bi-stable screen can include display message content for: display screen output as Notifications; display screen output as Operator Push output for messaging coming remotely from a network service or application in network communication with a network connection interface of the local client device; display screen output as news provided by a remote news network service or application in network communication with a network connection interface of the local client device; display screen output as social messages provided by a remote social messaging service or application in network communication with a network connection interface of the local client device; display screen output as social messages provided by a remote social networking service or application in network communication with a network connection interface of the local client device; display screen output as calendar information provided by a remote network service or application in network communication with a network connection interface of the local client device; and notification messages from a notification message provider remote from the local client device as a remote messaging service or application in network communication with a network connection interface of the local client device.

Alternatively, the display content examples for display on the bi-stable screen can include display content from a local application or service executing on the device, i.e. for content obtained or otherwise generated locally on the device infrastructure (e.g. local image or text obtained from local device storage) of the local client device, for: application or service executing on the device providing a local notification message for display on the screen; and application or service executing on the device providing a local static image (e.g. wallpaper, pictures from a camera roll, etc.) for display on the screen.

In combination, where the display screen is capable of changing selected portions of the display content, the display content examples for display on the bi-stable screen can include local display content obtained from a local application or service executing on the device combined with remote display content obtained from a remote application or service executing off the device, as: remote content of a notification message is a social network message displayed on local content of a social network screen; and remote content of notification message is a social network message displayed on local content of a Facebook page.

As recognised, the display content (e.g. message) can include content of an image; text; or text and image, as obtained locally (from local device memory) or remotely (as a communication originating from a remote network service or application via the communications network) for display on the bi-stable screen.

According to a first aspect is provided a method implemented by a computer device having a bi-stable screen as a one, and only one, screen for displaying display content associated with an application or service executable on the computer device, the method comprising: receiving the display content; and sending the display content for subsequent display on the bi-stable screen.

A further aspect provided is a computer device having a bi-stable screen as a one, and only one, screen for displaying display content associated with an application or service executable on the computer device, the computer device comprising software executable on the device to cause the device to: receive the display content; and send the display content for subsequent display on the bi-stable screen.

A further aspect provided is a method implemented by a computer device having a bi-stable screen for displaying display content associated with an application or service executable on the computer device, the method comprising: receiving the display content; and sending the display content for subsequent display on the bi-stable screen.

A further aspect provided is a computer device having a bi-stable screen for displaying display content associated with an application or service executable on the computer device, the computer device comprising software executable on the device to cause the device to: receive the display content; and send the display content for subsequent display on the bi-stable screen.

### BRIEF DESCRIPTION OF THE DRAWINGS

The detailed description is described with reference to the accompanying figures. The use of the same reference numbers in different instances in the description and the figures can indicate similar or identical items.

FIG. 1 is an illustration of an environment in an example implementation that is operable to employ display content techniques on an EPD enabled computing device;

FIG. 2 is a further embodiment of a computer device of FIG. 1;

FIG. 3 is a still further embodiment of a computer device of FIG. 1;

FIG. 4 is a flow diagram depicting a procedure in an example implementation of the notification processing of FIG. 3; and

FIG. 5 is a still further embodiment of a computer device of FIG. 1.

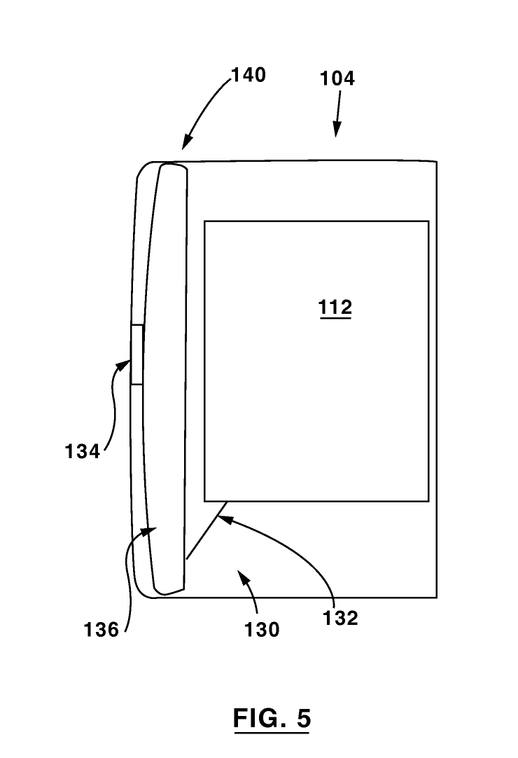

### DESCRIPTION

In the following discussion, an example environment is first described that can employ the techniques described herein. Example procedures are then described which can be performed in the example environment as well as other environments. Consequently, performance of the example procedures is not limited to the example environment and the example environment is not limited to performance of the example procedures.

The claimed invention can be implemented in numerous defined ways, including as a process; an apparatus; a system; a computer program product such as software embodied on a computer readable storage medium as physical memory; software embodied as asset of instructions when executed by a processor provide for the listed functionality expressed by the set of instructions in interaction(s) between the user and the device, operations/communication between or as a result of one or more processes (e.g. hardware processes, software processes) on the computer device, and for communication of data/information (e.g. display content) between the computing device and a remote network device; and/or a processor, such as a processor configured to execute instructions stored on and/or provided by the physical memory coupled to the processor. In this specification, these implementations, or any other form that the invention can take, can be referred to as techniques. In general, the order of the steps of disclosed processes can be altered within the scope of the claimed invention. Unless stated otherwise, a component such as a processor or a memory described as being configured to perform a task can be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the claimed invention is provided below along with accompanying figures that illustrate the principles of the invention. The claimed invention is described in connection with such embodiments, but the claimed invention is not limited to any embodiment. The scope of the claimed invention is limited only by the claims and the claimed invention encompasses numerous alternatives, modifications and equivalents. Numerous specific details are set forth in the following description in order to provide a thorough understanding of the claimed invention. These details are provided for the purpose of example and the invention can be practiced according to the claims without some or all of these specific details. For the purpose of clarity, technical material that is known in the technical fields related to the claimed invention has not been described in detail so that the claimed invention is not unnecessarily obscured.

The disclosure of any feature(s) within a paragraph and/or feature(s) in different paragraphs can be combined as evident to a person skilled in the art.

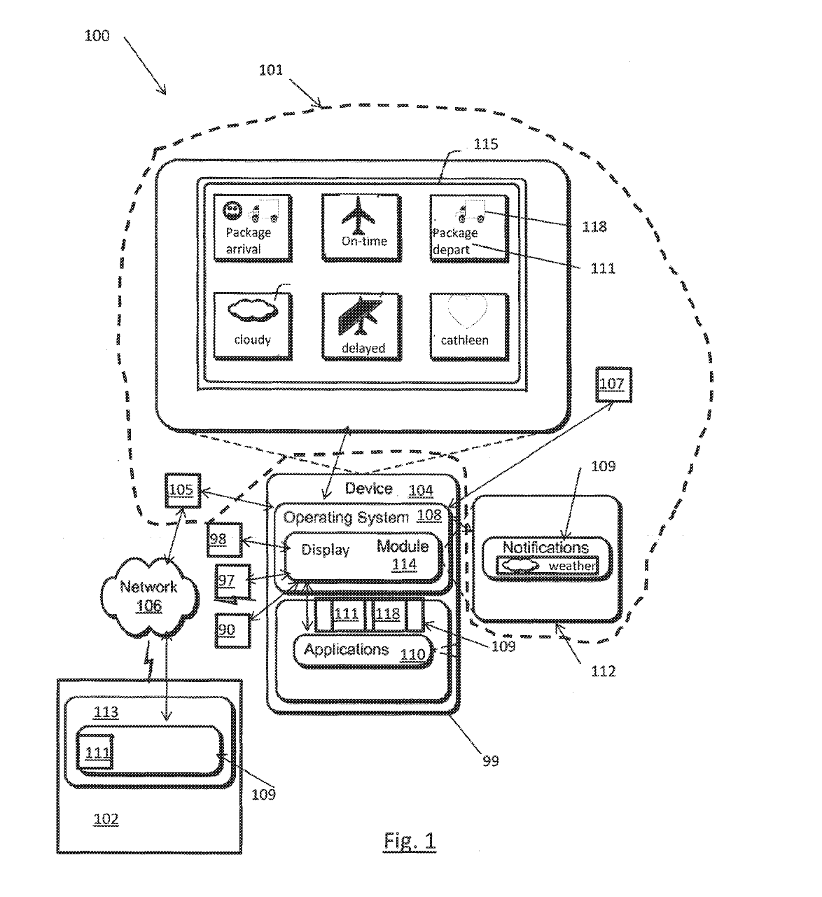

FIG. 1 is an illustration of an environment 100 in an example implementation that is operable to employ techniques described herein. The illustrated environment 100 includes a network device 102 (e.g. hosting a web service or other network application) and a client device 104 that are communicatively coupled via a network 106. The network device 102 can be implemented by a wide range of computing devices, such as but not limited to one or more servers. The client device 104 can be implemented by a wide range of computing devices, such as but not limited to a mobile device, a personal digital assistant, a smart phone, a tablet, a laptop, a desktop computer, an e-reader, etc. The client device 104 can be configured as a mobile device comprising one, and only one, screen wherein the screen is a bi-stable display screen (display device 112). Advantages of the client device 104 with the one, and only one, screen as the bi-stable display screen includes lower cost of the screen as compared to an LCD or LED based screen, greater durability and breakage resistance as compared to an LCD or LED based screen and/or lower power consumption of the screen unit (both in an active use mode in displaying/changing display content 109 of the display device 112 and in passive use mode when display content 109 is static and therefore not in the act of being displayed/changed by a display module 114 configured to process and render display content 109 as display output to the display unit 112) for subsequent viewing by a user of the client device 104.

As further described below, it is recognised that the following described and claimed inventions can be implemented in a number of different ways. One embodiment is where the display module 114 is responsible for coordinating display of display data 109 communicated to the display module 114 by one or more local services/applications 110 operating on the device infrastructure 101.

A further embodiment is where the display module 114 is responsible for coordinating display of display data 109 (e.g. received from remote applications/services 113 over the communications network) communicated to the display module 114 by one or more hardware components (e.g. network interface 105) operating on the device infrastructure 101, as communicated between the hardware component and the display module 114 by the operating system 108 and associated communication interface(s) and/or utility programs managed/utilized by the operating system 108.

A further embodiment is where the display module 114 is responsible for coordinating display of display data 109 communicated to the display module 114 by the operating system 108, as decided upon by the operating system 108 in comparison to a list 90 of device installed processes (e.g. application/service 110 processes and/or hardware processes) known to the operating system 108 as either in execution or in hibernation, or otherwise not on the list 90 of device installed processes, when the originally intended device installed process recipient of the display content 109 is one or more device installed processes (e.g. services/applications 110) existing in the hibernating state (also referred to as off state or non-execution state or disabled state) on the device infrastructure 101. In this manner, the decision by the operating system 108 is to bypass the intended target device installed process (for example as indicated/identified in a message containing the display content 109) and instead send the display content 109 directly to the display module 114, as the intended target device installed process is in hibernation mode. The display module 114 is able to either interpret/process the display content 109 using accessible defined data descriptors 98 (e.g. metadata for defining data type, data order, etc.) and/or defined data display format 97 (e.g. screen position, colour, font type, font size, etc.) made available to the display module 114. The display module 114 could have these defined data descriptors 98 and/or defined data display format 97 directly available to the display module 114 via the storage 105, for example. The display module 114 could request these defined data descriptors 98 and/or defined data display format 97 from the operating system 108 acting on behalf of the original intended target device installed process in hibernation mode, The display module 114 could obtain without request (e.g. have sent along with, in advance of, or subsequent to the sending of the display content 109 by the operating system 108) these defined data descriptors 98 and/or defined data display format 97 from the operating system 108 acting on behalf of the original intended target device installed process in hibernation mode.

A further embodiment is where the display module 114 is responsible for coordinating display of display data 109 received from remote applications/services 113 over the communications network 106, as communicated directly to the display module 114 by one or more hardware components (e.g. network interface 105) operating on the device infrastructure 101, as coordinated between the hardware component and the display module 114 by the operating system 108 and associated communication interface(s) and/or utility programs managed/utilized by the operating system 108. In this embodiment, the display module 114 would either have access to the list 99 of executing and/or non-executing device installed processes or could request information on the execution status/state of the original intended target device installed process for the display content 109. The display module 114 could make a decision based on available and accessible defined data descriptors 98 and/or defined data display format 97 related to the display content 109, whether the display module 114 is capable of sending to the display device 112 the display content 109 for display without needed involvement of the original intended target device installed process for the display content 109. The display module 114 could make a decision that involvement of the original intended target device installed process for the display content 109 is needed and then either send the display content 109 to the intended target device installed process for processing before being sent to the display device 112 for display, or request that the operating system send or otherwise make available the display content 109 to the intended target device installed process for processing before being sent to the display device 112 for display.

In view of the above, it is recognised that the display module 114 could be an application/service 110 being executed and coordinated by the operating system 108. In view of the above, it is recognised that the display module 114 could be incorporated as part of the operating system 108, for example as one service utility of the common set of utilities managed and used by the operating system 108 and made available to the applications/services 110 and/or hardware component processes provisioned or otherwise installed on the client device 104. Examples of the utilities are data access from memory, or other data operations, as implemented by the device infrastructure 101 under direction of the operating system 108.

The local client device 104 can be configured as a computer device that is capable of communicating over the network 106, such as a mobile communication device (e.g. a wireless phone, wireless tablet, etc. as illustrated for the client device 104), and so forth. Thus, the local client device 104 can range from full resource devices with substantial memory and processor resources to a low-resource device with limited memory and/or processing resources (e.g. hand-held game consoles). Additionally, a computing device for network device 102 can be representative of a plurality of different devices, such as multiple servers utilized by a business to perform operations and so on. In any event, it is preferred that that the client device 104 is configured as a smart enabled device (e.g. phone/tablet with capabilities including network 106 connection with network messaging ability for obtaining display content 109 such as notifications obtained remotely over the network 106). Also considered is that the smart enabled device can be configured to send and receive communication data for phone feature messaging (e.g. voice messaging, text messaging such as SMS, email communication, image messaging, etc.). It is also considered that that a smart enabled device is defined as being capable of receiving a notification message sent as a push notification (e.g. an operator push) forwarded over the network 106 by the network device 102 for receipt by the client device 104 (e.g. by the network interface 105). A push notification, or server push, or operator push describes a style of network 106-based communication (e.g. display content 109) where the request for a given transaction (sending of display content 109 as the operator push over the network 106 for receipt by the client device 104) is initiated by the publisher or central server device 102. A push notification, or server push, or operator push is contrasted with pull notification or server pull, or operator pull, where the request for the transmission of information (sending of display content 109 as the network communication over the network 106 for receipt by the client device 104) is initiated by the receiver or client device 104.

Example features of a smart enabled device 104 can include features such as but not limited to high-resolution touch screens (display device 112) and web browsers (implemented by an operating system 108) that display standard web pages and other display content 109 as well as mobile-optimized sites (e.g. network devices 102 providing remote network application(s)/service(s) 113 connected via the network 106-to the client device 104 via a network interface 105. High-speed data access for the display content 109 can be provided by Wi-Fi and mobile broadband as examples of the network capabilities of the network interface 105. Further, the operating system 108 is capable of executing local application(s)/service(s) provisioned on the device infrastructure 101, as obtained (e.g. downloaded from network 106) from mobile app markets and mobile commerce related network devices 102. The mobile operating systems (OS) 108 used by modern smart phones can include Google's Android, Apple's iOS, Nokia's Symbian, Blackberry Ltd's BlackBerry OS, Samsung's Bada, Microsoft's Windows Phone, Hewlett-Packard's webOS, and embedded Linux distributions such as Maemo and MeeGo. Such operating systems 108 can be installed on many different phone models of the client device 104, and typically each client device 104 can receive multiple OS software updates over its lifetime.

Further, one of the differences between smart enabled devices and non-smart enabled devices (e.g. feature phones, e-readers, e-books, etc.) is that the advanced application programming interfaces (APIs) are programmed into the device infrastructure 101 for running third-party applications/services 110, display module 114, etc., which can provide for those applications/services 110 integration with the phone's OS 108 and hardware (of device infrastructure 101). Typical feature phones and other non-smart phones do not have APIs that are programmed and may only have some limited network 106 connectivity. The hardware of the device infrastructure 101 can include hardware components such as but not limited to: antenna(a) of network interface 105; camera including camera lenses and/or camera sensor (e.g. CMOS); sensors such as motion sensors, temperature sensors, etc.; touch screen 112 sensor, microphone, speaker, physical control buttons such as on/off, volume control, camera button, etc.; microphone; memory such as flash drive by example only; various computer processors; computer BUS; and/or connection ports such as USB, speaker jack, headphone jack, power jack, and any dedicated network 106 jack, etc.

Although the network 106 is illustrated as the Internet, the network 106 can assume a wide variety of configurations. For example, the network 106 can include a wide area network (WAN) such as the Internet, a local area network (LAN), a wireless (e.g. WiFi, Bluetooth, etc.) network, a public telephone network, an intranet, and so on. Further, although a single network 106 is shown, the network 106 can include multiple networks.

The client device 104 is further illustrated as including an operating system 108. The operating system 108 is configured to abstract underlying functionality of the client 104 to local applications 110 or local services 110 that are executable on the client device 104 via a device infrastructure 101. For example, the operating system 108 can abstract processing functionality by device infrastructure components (e.g. power source such as a battery, processors 107, memory 115 for display content 109 data access and storage, network interface 105 to network 106 for sending/receiving communications including content 109 for display to and from the network device 102, and/or display functionality of the display screen 112) such that the local applications 110 or local services 110 can be executed by the device infrastructure 101 without knowing “how” this underlying functionality is implemented. The local application 110 or local service 110 can, for instance, provide display content 109 (e.g. messages such as but not limited to notification(s)) containing text content 111 (e.g. text data) and/or image content 118 (e.g. picture data) to the operating system 108. The operating system 108 can utilize the display module 114 (as further described below) to identify, process, render and/or display the display content 109 provided to the bi-stable display device 112, without understanding how this rendering will be performed by the bi-stable display device 112 and associated display circuitry provided as part of the display device 112.

For example, the display device 112 can be embodied as a display unit coupled (e.g. electronically wired/connected and/or wirelessly connected) to other interconnected device infrastructure components (e.g. memory 115, processors 107 coupled to memory 115, on-board devices such as network interface 105, etc.) leveraged by the operating system 108. The network interface 105 can be a wireless network interface, can be a wired network interface such as a USB interface, etc. and can therefore be configured with communication protocols used to transfer (e.g. receive/send or send/receive) the display content data 109 over the network 106 between the client device 104 and the network device 102.

The operating system 108 can also represent a variety of other functionality, such as to manage a file system and a user interface that is navigable by a user of the client device 104. An example of this is an application launcher (e.g. available via a desktop screen or menu) that is displayed on the display device 112 of the client device 104. The desktop can include representations of a plurality of the applications/services 110, such as icon, tiles, textual descriptions. The desktop can be considered a root level of a hierarchical file structure. Further, operating system 108 can have one or more processors 107 used to execute instructions to perform operations and functionality/processing (e.g. rendering display of display content 109 to the display, accessing memory 115) of the operating system 108 as well as to perform operations and functionality/processing of the display module 114 (e.g. analyzing and performing changes to the content of the display content 109 for subsequent generation and display). Images 118 and associated defined text 111 in the memory 115 shown in the illustrated example can be used by the display module 114 in order to generate the display content 109 for display on the display 112 of the client device 104. In this way, a user can readily see display content 109 of interest on the display 112. It is also recognised that any of the applications/services 110 can use the images 118 and associated defined text 111 in the memory 115 in order to generate the display content 109 for display on the display 112 of the client device 104.

It is also recognised that the operating system 108 can abstract underlying functionality of the client 104 to remote applications 113 or remote services 113 that are executable on the network device 102 and are in communication with the network interface 105 of the device infrastructure 101 via the network 106. For example, the operating system 108 can abstract processing functionality by device infrastructure components (e.g. power source such as a battery, processors 107, memory 115 for content 109 data access and storage, network interface 105 to network 106 for sending/receiving communications including content 109 for display to and from the network device 102, and/or display functionality of the display screen 112) such that the display content 109 provided by the remote applications 113 or remote services 113 can be executed by the device infrastructure 101 without knowing “how” this underlying functionality is implemented. The remote application 113 or remote service 113 can, for instance, provide display content 109 (e.g. messages such as but not limited to notification(s)) containing text content 111 (e.g. text data) and/or image content 118) to the operating system 108, as received and made available by the network interface 105. The operating system 108 can utilize the display module 114 (as further described below) to process, render and/or display the display content 109 provided to the bi-stable display device 112, without understanding how this rendering will be performed by the bi-stable display device 112 and associated display circuitry provided as part of the display device 112.

The operating system 108 can also represent a variety of other functionality, such as to manage a file system and a user interface (e.g. display device 112 as a touch screen) that is navigable by a user of the client device 104. An example of this is an application launcher (e.g., desktop) that is displayed on the display device 112 of the client device 104. It is recognised as discussed above that the display content 109 can also be obtained remotely over the network 106 from the remote application 113 or remote service 113 executing on the remote network device 102 (e.g. network server).

The operating system 108 can selectively run the computer hardware components of the device infrastructure 101 and can also selectively execute (e.g. start selected-application/service 110 as an executing process on process stack, end execution of selected application/service 110 as an executing process on process stack, and/or is aware of what processes are executing and what processes are in hibernation—also referred to as low power mode for those processes) the applications/services 110 software provisioned on the device infrastructure 101. In this sense, executing processes and non executing (e.g. stopped, hibernating, off-state, etc.) information can refer to both or either available hardware components (e.g. camera, microphone, speaker, network interface, user interface such as touch screen, volume controls, power button, etc.) as well as software/service 110 provisioned on the device 104. Executing processes and non executing (e.g. stopped, hibernating, off-state, etc.) process information can be used by the operating system 108 in deciding whether to direct display content 109 directly to the display module 114 (thereby bypassing the application/service 110 in hibernation) and/or to direct the display content 109 directly to the application/service 110 in execution which in turn sends the display content 109 on to the display module 114 for subsequent sending (and optional processing) to the display device 112 for display to the user. Alternatively, the operating system sends display content 109 (e.g. received from network 106) directly to the display module 114 (thereby bypassing the application/service 110 in hibernation or in execution state) and executing processes and non executing (e.g. stopped, hibernating, off-state, etc.) process information (e.g. as requested or otherwise obtained from the operating system 108) can be used by the display module 114 in deciding whether to direct display content 109 to the target application/service 110 in execution (or to request the operating system 108 to change the target application/service 110 from the hibernation state to the operation/execution state) and to direct the display content 109 to the target application/service 110 in execution for processing the display content 109 before subsequent sending (and optional processing/handling by the display module 114) to the display device 112 for display to the user.

The operating system 108 provides that the hardware processes (e.g. components 115, 107,105, 112, etc.), the applications/service 110 software processes, and the display module 114 process understand each other and can communicative with one another using defined communication interfaces that act as an entity or creates a medium of interaction or communication between one or more of the processes. One example is the operating system 108 interface to facilitate communication of user events received by the user-interface (e.g. touch screen device 112) as the means of interaction between the user and the client device 104.

The operating system 108 also comes with utilities, which are pieces of Applications Software (e.g. executable instructions) that mostly deal with managing data on the client device 104 and to and from the client device 104, thereby providing a set of common services for various processes in execution. Utilities Programs manage, repair, and/or optimize data on the client device 104. Time-sharing aspects of the operating system 108 can be used to schedule tasks, including facilitating the bypass decision of selected application/services 110 (and/or hardware) in hibernation (e.g. off state, non-executing, etc.) when providing for the display of the display content 109. Also, time-sharing aspects of the operating system 108 can be used to schedule tasks, including being involved in any decision of the display module 114 and/or the operating system 108 that the received display content 109 cannot be sufficiently processed by the predefined data descriptors 98 and/or predefined display format descriptors 97 and therefore acting on instruction of the display module 114 and/or the operating system 108 to bring selected application/service 110 and/or hardware out of hibernation (e.g. start execution) by the operating system 108.

In this case, the display content 109 can be processed by the selected application/service 110 and/or hardware component so that the display module 114, optionally, can then subsequently provide the display content 109 to the display device 112 for display to the user. Accordingly, via the knowledge of executing processes, as well as available non-executing processes, the operating system 108 and/or the display module 114 can facilitate efficient use of the system battery life, and may also include accounting software for cost allocation of processor time, mass storage, printing, and other resources, for operation of the display module 114 in providing correctly identified/recognized and display formatted display content 109 to the display device 112, with or without (e.g. bypass) the normally involved application/service 110 and/or hardware when executing as a process on the device infrastructure 101. It is recognised that the display module 114 can be referred to as a configurable (e.g. programmable) display driver for coordinating the display of the display content 109 on the display device 112.

For hardware functions of the operating system 108 interfaces, such as input and output and memory allocation, the operating system 108 acts as an intermediary between programs 110,114 and the computer hardware. Although the program 110,114 code is usually executed directly by the hardware and will frequently make a system call to an operating system 108 function or be interrupted by it. As such, the operating system 108 has an event-driven or time-sharing design and often aspects of both. An event-driven operating system 108 switches between tasks needed by the programs 110,114 and/or hardware based on their priorities or external events while time-sharing operating systems switch tasks based on clock interrupts, for example, as configured by the system for use in facilitating making the decision to bypass or not selected application/service 110 and/or hardware that are related to processing of the display content 109 when they are executing processes (e.g. in the case of hardware, an executing hardware process would involve power consumption from the battery power source of the client device 104). It is recognised that the display content data 109 can come from the local application/service 110 and/or can be received via the network connection interface 105 by remote application 113 or remote service 113 hosted by the network device 102.

Examples of the remote application 113 or remote service 113 and related remotely obtained display content 109 is as follows: changing the device appearance of a device case 99 is as context-related content; the context-related device case 99 appearance can include location-based advertising; the device appearance case 99 can be changed to give an appearance of a different phone case when the bi-stable display screen appears to be part of the device case 99; the device skin of the device case 99 can be changed as provided by the display content when the bi-stable display screen appears to be part of the device case 99; and the device skin can be changed by the display content to show one or more of wallpaper, photos, movies, or user-customized content when the bi-stable display screen appears to be part of the device case 99; display screen output as a social network screen; display screen output as social aggregator output or social network output; display screen output as the social aggregator output or social network output as a Facebook page; display screen output as device location related details provided by a remote server (e.g. triangulation information); display screen output as a Google search page; and display screen output as results of a location-based search; display screen output as Notifications; display screen output as Operator Push output for messaging coming remotely from a network service or application in network communication with a network connection interface of the local client device; display screen output as news provided by a remote news network service or application in network communication with a network connection interface of the local client device; display screen output as social messages provided by a remote social messaging service or application in network communication with a network connection interface of the local client device; display screen output as social messages provided by a remote social networking service or application in network communication with a network connection interface of the local client device; display screen output as calendar information provided by a remote network service or application in network communication with a network connection interface of the local client device; and/or notification messages from a notification message provider remote from the local client device as a remote messaging service or application in network communication with a network connection interface of the local client device.

The operating system 108 is also illustrated as interacting with the display module 114. The display module 114 is representative of functionality to manage display content 109 (e.g. notifications) that is to be displayed. As further discussed below, by example, an image representation 118 (e.g. cloud) associated with text 111 (e.g. cloudy) stored in the storage 115 can be used by the display module 114 to process and display on the display device 112. In this way, a user can readily view information relating to the received notifications 109 on the display device 112, such that the text content 111 of the notification 109 has been provided by the notification module 114 to generate and subsequently display with the image representation 118 matched to the text 111 as determined by the notification module 114.

It is recognised that the display module 114 could receive and process the display content 109 without having to launch and navigate through each of the local applications/services 110. Although representations of specific local applications/services 110 are shown, other representations of local applications/services 110 are also contemplated, such as a representation of a local application/service 110 that references a user's involvement with a network service 113 for remotely obtained display content 109, e.g. from a friend connected via a social network service hosted by the network device 102.

In one or more implementations, the display content 109 can be managed without executing the corresponding specific local application(s)/service(s) 110. For example, the display module 114 can receive the display content 109 (e.g. local and/or remote) from a variety of different sources, such as from software (e.g., other local applications/services 110 executed by the client device 104) and/or from a remote web service device 102 via the network 106. The display module 114 can then manage how the display content 109 is processed and then displayed as display content 109 without executing one or more local applications/services 110 related (e.g. associated or otherwise identified as a target application/service according to application identification information coupled to the display content 109—e.g. as part of a communication message containing the display content 109 and/or as part of a script/instruction set implemented by the operating system 108) to the display content 109.

For example, an application/service 110,113 can provide display content 109 related to calendar data (e.g. date/time), however the local target/identified calendar application 109 usually used to process and send this display content 109 to the display module 114 can be turned off or otherwise in a dormant state as implemented by the operating system 108. In this instance, the display content 109 would contain predefined data descriptors 98 (e.g. metadata) known to the display module 114 that would allow the display module 114 to recognise and display the display content 109 using predefined display format(s) 97 also known to the display module 114. In other words, the display module 114 is configured by data descriptor definitions 98 and/or display format definitions 97 of the identified (e.g. via application ID of the display content 109) target application(s)/service(s) 110. As such, the device infrastructure 101 can communicate the display data 109 (e.g. remotely obtained) directly to the display module 114 and thus bypass involvement of the local application/service 110, in a deactivated state, that would normally receive such remote display data 109 (or locally generate similar display data 109). As such, the display module 114 could be selected by the operating system 108 (and related device infrastructure 101components) to receive display data 109 normally directed or otherwise addressed to another local target application/service 110 when such target application/service 110 is in a suspended, deactivated, or otherwise non-executing state as understood by the operating system 108. Alternatively, the display module 114 can receive the display content 109 from the operating system 108 and decide whether to involve the identified target application/service 110, or not, in display of the display content 109 on the display device 112. In the case where the identified target application/service 110 is in a hibernation state, the display module 114 could request the operating system 18 to start the target application/service 110 to assist or otherwise cause the display content 109 to be submitted to the display device 112. As such, it is recognised that an application/service 110 in hibernation can be substituted by one skilled in the art for a non-powered or “off” state hardware device. For example, the operating system 108 and/or the display module 114 could decide, upon receipt of the display content 109, that user interaction is required and request that additional processing instructions for the display content 109 be collected from the user via a hardware device that needs to be changed from a non-powered state to a powered state (e.g. microphone and associated microphone listening application).

Another example of a non-powered or “off” state hardware device is where the display content 109 is an image 118 obtained as remote display content 109 from a remote application/service 113 via the network 106. In this case the local camera application 110 is turned off (non-executing as per the operating systems) and associated (of the camera application 110) device infrastructure 101 component of a camera sensor and associated hardware components (e.g. CMOS sensor) remains in an “off” state and are therefore not powered (i.e. unpowered) by the power source (e.g. battery) of the client device 104. As such, upon receipt of the remote display content 109, the operating system 108 is configured to retain the off state of the local camera application 110 and any hardware devices and redirect the received remote display content 109 to the display module 114 for processing and display of the remote display content 109 using the predefined data descriptors 98 and/or predefined display formatting 97.

Alternatively, another example of a non-powered or “off” state hardware device is where the display content 109 is an image 118 obtained as remote display content 109 from a remote application/service 113 via the network 106. In this case the local camera application 110 is turned off (non-executing as per the operating systems) and associated (of the camera application 110) device infrastructure 101 component of a camera sensor and associated hardware components (e.g. CMOS sensor) is in an “off” state and are therefore not powered (i.e. unpowered) by the power source (e.g. battery) of the client device 104. As such, upon receipt of the remote display content 109, the operating system 108 changes the off state of the local camera application 110 to an on state and any associated hardware devices and redirects the received remote display content 109 to on state components (i.e. those brought out of hibernation) for processing and display of the remote display content 109 using the predefined data descriptors 98 and/or predefined display formatting 97.

In view of the above, in general, a local application/service 110 can generate local display content 109, however a local target application/service 109 (and/or related computer hardware device component of the device infrastructure 101) usually used to process and send this locally obtained/generated display content 109 to the display module 114 can be turned off or otherwise dormant as implemented by the operating system 108. In this instance, the local display content 109 would contain data compatible (e.g. in a recognizable format) with predefined data descriptors 98 (e.g. metadata) known to the display module 114 and/or the operating system 108 that would allow the display module 114 to recognise and display the local display content 109 using predefined display format(s) 97 also known to the display module 114 and/or the operating system 108.

In other words, the display module 114 can be configured by data descriptor definitions 98 and/or display format definitions 97, also known to one or more of the target application(s)/service(s) 110 that they use to also process and send the same local display content 109 to the display module 114, for subsequent sending and display by the display device 112. As such, the device infrastructure 101 can communicate the local display data 109 (e.g. locally obtained) directly to the display module 114 and thus bypass involvement of the local target application/service 110 (and/or related target computer hardware device component of the device infrastructure 101), present in a deactivated state, that would normally receive such local display data 109 (or locally generate similar display data 109). As such, the display module 114 could be selected by the operating system 108 (and related device infrastructure 101components) to receive local display data 109 normally directed or otherwise addressed to another local target application/service 110 when such application/service 110 is in a suspended, deactivated, or otherwise non-executing state as understood by the operating system 108.

Alternatively, in view of the above, in general, a remote application/service 113 can send remote display content 109 for receipt by the operating system 108 (or otherwise as processed by the device infrastructure 101), however a local application/service 109 (and/or related computer hardware device component of the device infrastructure 101) usually used to receive, process and send this remotely obtained display content 109 to the display module 114 can be turned off or otherwise dormant as implemented by the operating system 108. In this instance, the remote display content 109 would contain data compatible with predefined data descriptors 98 (e.g. metadata) known to the display module 114 and/or the operating system 108 that would allow the display module 114 to recognise and display the remote display content 109 using predefined display format(s) 97 also known to the display module 114. In other words, the display module 114 is configured by data descriptor definitions 98 and/or display format definitions 97, also known to one or more of the local application(s)/service(s) 110 that they use to also process and send the same remote display content 109 to the display module 114, for subsequent sending and display by the display device 112. As such, the device infrastructure 101 can communicate the remote display data 109 (e.g. locally obtained) directly to the display module 114 and thus bypass involvement of the local target application/service 110 (and/or related computer hardware device component of the device infrastructure 101), in a deactivated state, that would normally receive such remote display data 109 (or locally generate similar display data 109). As such, the display module 114 could be selected by the operating system 108 (and related device infrastructure 101components) to receive remote display data 109 normally directed or otherwise addressed to a local application/service 110 when such local application/service 110 is in a suspended, deactivated, or otherwise non-executing state as understood by the operating system 108.

This bypassing of a local application/service 110 and/or associated device hardware component in a suspended, deactivated, or otherwise non-executing non-powered state can be used to improve battery life and performance of the client device 104 by not running each of the local application/service 110 (and/or device hardware component) to output the display remote/local data content 109 to the display device 112 for display. In other words, it is recognised that the display device 112 as a bi-stable screen provides for the remote/local display content 109 (e.g. notifications) to be displayed on the display device 112 with the bypassed local application/service 110 in a off or non-executing state. As such, the remote/local display content 109 could be rendered and displayed on the bi-stable screen display device 112 when operated in a low power display content mode, e.g. low power notification mode, when one or more client device 104 hardware components (e.g. on-board devices, coupled peripheral devices, etc.) and/or one or more local application/service 110 managed by the operating system 108 (and normally used for receiving and processing or otherwise generating this display content 109 and then sending to the display module 114) are in an off or non-executing state in order to conserve power of the computer device 104.

Application display content techniques and types are described. Implementations are described in which a local application 110 and/or remote application/service 113 can send content (e.g. message content such as notifications) that pertain to one or more active or deactivated local application/service 110 for display on the bi-stable screen display device 112. Techniques which can be used to manage the display content 109 such as notifications, includes replacement of notifications, use of queues, overrides, selection of notifications based on execution state of an application, cycling a display of a plurality of notifications (e.g., by a user or automatically by a computing device), cycling a display of different subsets of notifications, examination of a manifest of an application to determine criteria to be used to display the notifications, display priority of the notifications, and so on.

Other display content 109 examples for display on the bi-stable screen display device 112 can include display content 109 for: changing the device appearance is as context-related content; the context-related device appearance can include location-based advertising; the device appearance can be changed to give an appearance of a different phone case 99 when the bi-stable display screen appears to be part of a device case 99; the device skin of the device case 99 can be changed as provided by the display content when the bi-stable display screen appears to be part of a device case 99; and the device skin can be changed by the display content to show one or more of wallpaper, photos, movies, or user-customized content when the bi-stable display screen appears to be part of a device case 99. These display content 109 examples can be performed by the display module 114 using the display content 109 obtained as local content from local application(s)/service(s) 110 and/or using content obtained as remote content 109 from remote application(s)/service(s) 113.

Other display content 109 examples for display on the bi-stable screen 112 can include display content 109: display screen output as a social network screen; display screen output as social aggregator output or social network output; display screen output as the social aggregator output or social network output as a Facebook page; display screen output as device location related details provided by a remote server (e.g. triangulation information); display screen output as a Google search page; and display screen output as results of a location-based search. These display content 109 examples can be performed by the display module 114 using the display content 109 obtained as remote content 109 from remote application(s)/service(s) 113.

Other display content 109 examples for display on the bi-stable screen 112 can include display content 109: display screen output as Notifications; display screen output as Operator Push output for messaging coming remotely from a network service or application in network communication with a network connection interface of the local client device; display screen output as news provided by a remote news network service or application in network communication with a network connection interface of the local client device; display screen output as social messages provided by a remote social messaging service or application in network communication with a network connection interface of the local client device; display screen output as social messages provided by a remote social networking service or application in network communication with a network connection interface of the local client device; display screen output as calendar information provided by a remote network service or application in network communication with a network connection interface of the local client device; and notification messages from a notification message provider remote from the local client device as a remote messaging service or application in network communication with a network connection interface of the local client device.

Alternatively, display content 109 examples for display on the bi-stable screen 112 can include display content 109 from a local application or service 110 executing on the device 104, i.e. for content obtained or otherwise generated locally on the device infrastructure 101 (e.g. local image or text obtained from local device storage) of the local client device 104, for: application or service executing on the device providing a local notification message for display on the screen; and application or service executing on the device providing a local static image (e.g. wallpaper, pictures from a camera roll, etc.) for display on the screen.

In combination, where the display screen 112 is capable of changing selected portions of the display content 109, the display content 109 examples for display on the bi-stable screen 112 can include local display content 109 obtained from a local application or service 110 executing on the device combined with remote display content 109 obtained from a remote application or service 113 executing off the device 104, as: remote content 109 of a notification message is a social network message displayed on local content of a social network screen; and remote content 109 of notification message is a social network message displayed on local content of a Facebook page.

As recognised, the display content 109 (e.g. message) discussed above can include content of an image, text, or text and image, and/or content of a video card or video data stream or file, as obtained locally (from local device memory 115 via local service or application 110) or remotely (as a communication originating from a remote network service or application 113 via the communications network) for display on the bi-stable screen 112.

Further to the above, the display module 114 can be configured as executed instructions (e.g. software) by the device infrastructure 01 (e.g. via one or more processors 107) to facilitate the receipt of the display content 109, optionally perform any processing or preprocessing of the display content 109, and send the display content 109 for display by the display device 112.

The notification module 114 can utilize a variety of techniques to enable recognition and specification of how the display content 109 are to be displayed and managed. For instance, the display content 109 can be associated with the predefined text and/or corresponding predefined images 118 as defined and stored in the storage 115. Further predefined data 98 and/or formatting 97 and optionally along with corresponding identifying and/or displaying criteria can specify how the display content 109 are to be processed, displayed and/or managed. Thus, an originator of the predefined text and corresponding image (and optionally corresponding identifying and/or amending criteria) can specify how corresponding display content 109 are to be displayed or managed. This can be performed by the display module 114 to enable a variety of different functionality.

Example operations of the display module 114 are provided below, using the display content 109 example of a notification message 109. The display module 114 of the following example operations is referred to by example only as “computer program product”, “software”, etc., whereby such terminology can be substituted by “executable instructions for execution by a computer processor”, as understood by a person skilled in the art. As discussed above, the display module 114 can also be embodied as a display driver 114.

For example, a display driver 114 can be defined as a semiconductor integrated circuit (but may alternatively comprise a state machine/device made of discrete logic and other components) which provides an interface function between a microprocessor 107, microcontroller 107, ASIC or general-purpose peripheral interface and the display device 112. The display driver 114 can typically accept commands and data using configured serial or parallel interface, and generate signals/commands (e.g. with suitable voltage, current, timing and demultiplexing, as useful) to make the display device 112 show the desired display content 109 (e.g. text and/or image). The display driver 114 can itself be an application-specific microcontroller 107 and can incorporate RAM, Flash memory, EEPROM and/or ROM. Fixed ROM can contain firmware, display fonts, display formats, etc.

According to an aspect there is provided a computer program product 114 operable to provide notification messages 109 on a device 104 operating at low power, the device 104 comprising front and back major faces, the front major face arranged to present a primary display screen 112 and the back major face arranged to be absent (e.g. does not contain) a display screen for use in displaying the display content 109 as contemplated herein, wherein the display screen 112 is a bi-stable display screen. The computer program product 114 when running on the device 104 operable to provide the steps of: receive a notification message 109 and display the notification message 109 on the bi-stable display screen 112. Further, the method can comprise the step of: the software 114 determining if the notification message 109 is a new notification message 109 (i.e. not previously displayed), and the bi-stable display screen 112 is updated only if the notification message 109 is a new notification message 109. The method can be one in which the notification message 109 is displayed on the bi-stable display screen 112 at a preselected (i.e. configurable and selectable or otherwise variable) screen update frequency. It is recognised that the method may be one in which notification message 109 display time is not limited, because a bi-stable display 112 is used. The screen update frequency (maximum, minimum, etc.) is a user settable parameter in the software 114.

An example of interactions is text messages 109 from a remote blog site. An example of control is varying the frequency of screen 112 updates e.g. from once per minute to once per 5 minutes. An example of use cases of the display content 109 is receipt of a major emergency notification 109 by an emergency services worker via the network 106. An example of personalization is putting a photo 109 of a favourite landmark on the screen 112, as generated by a local application 110 for example. An example of privacy is removing names of companies or individuals (or other text 111 and/or pictures 118) from any received display content 109 (e.g. remote and/or local), as preprocessed by the display module 114 to generate amended display content before submitting the amended display content for display on the screen 112.

As examples of display content 109, the display device 112 can display news provided by a news service. The display device 112 can display social messages provided by a social messaging service. The display device 112 can display output providing social aggregator output or social network output. The social aggregator output or social network output cab be a Facebook page.

The display device 112 can be the only operational display of the device for displaying the display content 109 and can be configured to capitalize or otherwise accommodate (e.g. bypassing target application/service 110 and/or associated hardware devices in hibernation) when the device infrastructure 101 operates in the low power (e.g. notification) mode as discussed. When the device infrastructure 101 operates in a low power notification mode, the display device 112 can be updated in response to an incoming news story provided by a news service. When the device infrastructure 101 operates in a low power notification mode, the display device 112 can be updated in response to an incoming social message provided by a social messaging service. The device infrastructure 101 can be programmed (e.g. via the operating system 108 and/or display module 114 capable of decision making as described) such that when the device infrastructure 101 operates in a low power notification mode, the display device 112 displays content updates of one or more categories, for example, news, social messages, an emergency notification, financial news, earthquake, tsunami or weather. The categories may be preselected, such as by a user or by a network services provider. As discussed herein, examples of display content 109 can be: screen 112 output provides Notifications; screen 112 output provides Operator Push output; screen 112 output provides news provided by a news service.; screen 112 output provides social messages provided by a social messaging service; screen 112 output provides an indication of mobile phone signal strength; screen 112 output provides an indication of battery charge state; screen 112 output provides calendar information; display 112 of the device 104 is the only operational display of the device 104 when the device 104 operates in a low power notification mode.

Other operational examples of the display module 114 include display of the display content 109 moderated as content updates of one or more categories when the device 104 operates in a low power mode (i.e. one or more applications/services 110 are non-executing by the operating system 108 and/or one or more computer device hardware components of the device infrastructure 101 are in an off state and thus conserving battery power). The categories can include prioritized categories of one or more of news, social messages, an emergency notification, financial news, earthquake, tsunami or weather. The categories can be preselected. The categories can be preselected by a user via the user interface of the device infrastructure 101. The categories can be preselected by a network services provider upon setup of the operating system 108 and associated applications/services 110 and/or can be selected using communications received via the network 106.

It is recognised that the applications/services 110,113 can be, for example, web browsers, corporate email applications, corporate address books, work calendars, and other enterprise applications, games, downloaded custom apps, and music apps. Alternatively, the applications/services 110,113 can be corporate/Work Calendar; Corporate/Work Mail; Corporate/Work Directory and Address Book; Company News (e.g. RSS, XML, etc); Instant Messaging (e.g. What's app, Skype, etc); Job dispatcher, Tasks and to-do-list; Recorder for meeting; Notes; Storage, reports and documents (e.g. xis, ppt, doc, etc); Stock prices; Secured network connectivity/connection manager. Examples of applications/services 110,113 can include applications such as but not limited to: Social Networking (e.g. Facebook, Blog, Twitter, Line, Sina, etc); Multimedia recording, playback and sharing (e.g. video, audio, photo, music, etc); Games and apps; Personal Alarm and tasks; Instant Messaging (e.g. Yahoo!, Google, What's app, MSN, Skype, etc); Point of Interests, Navigation and Geo-fence (e.g. Map tools); My wallet (e.g. banking, statement, NFC payment, auction & bidding/taoboa, etc); Storage and backup on 3Cloud; Utilities/Tools (e.g. stock, apps, widgets, calculator, weather, etc); Tariff and unbilled usage counter/widget (personal) for a network 106 data/usage plan.

The image 118 can be defined as a computer icon, a pictogram or other image (or series of images) displayed on the screen 112 statically and/or and used to navigate to or within the applications/services 110,113 environment afforded by the operation system 108. The image 118 itself can be a small picture or symbol serving as a quick, “intuitive” representation of the text content 111. The image 118 can function as an electronic hyperlink or file shortcut to access the applications/services 110,113 or data in the storage 115. The image 118 can be a small picture that represents objects such as a file in the storage 115 or applications/services 110,113 itself or functionality within the file or applications/services 110,113. The image 118 can be used as a quick way (e.g. one selection shortcut) to execute commands, open documents/files, and run programs, as interpreted by the operating system 108.

Notifications 109 (e.g. text messages) can be used by applications 110,113 to display information (e.g. SMS notification, email, etc.) obtained from applications 110,113 without having the user specifically launch one or more related local applications 110, or can be obtained from the applications 110,113 with the user having launched the corresponding local application 110. For example, a weather application can send for display a notification that describes current weather conditions. Another example of a notification sent for display can be a text message (e.g. one friend sending an electronic message of hello to another friend) sent from another computer device 102 connected via a communication network 106 to the computer device 104 displaying the notification. Techniques that are utilized to display notifications can be static and/or configured to control how the notifications are displayed on a user interface 112 of a computer device 104. It is recognised that the application 110 sending the notification 109 can be hosted on the computer device 104 displaying the notification on its user interface 112 and/or the application 113 can be hosted by a network service or other computer device 102 in communication over a communications network 106 with the device 104 displaying the notification on its user interface 112.

Techniques described herein can be used to manage notifications 109, including processing notifications received from applications 110,113 and then displayed as notifications on the computer device display 112. Additionally, in one or more implementations these techniques can be performed without executing a corresponding application 110, thereby conserving battery life and increasing performance of local client devices 104 that perform these techniques (for example when notifications are displayed on the low power screen 112 such as an e-ink or electronic paper display EPD acting as a bi-stable screen display 112—see FIG. 1). Examples of a variety of different techniques are applicable and relate to application notifications 109, such as receipt of notifications, analyzing text content of the notifications, selection of one or more text portions of the notification text content based on matching with predefined text portions (e.g. a word, a grouping of words, a pattern of words, a word phrase, etc.), amending the notification text content based on the results of the text portion matching, displaying one or more received notifications as amended notifications, following criteria used to amend and/or display the notifications, determine priority of the notifications and/or content within the notifications, and so o.

Notifications 109 can be referred to as text messaging, or texting, the act of typing and sending a brief, electronic message between two or more mobile phones or fixed or portable devices 102,104 over a network 106, see FIG. 1. The term text message can refer to messages sent using the Short Message Service (SMS) and can refer to messages containing image, video, and sound content (known as MMS messages). The sender of the text message is known as a texter, while the service itself has different colloquialisms depending on the region. It may simply be referred to as a text in North America, the United Kingdom, Australia and the Philippines, an SMS in most of mainland Europe, and a TMS or SMS in the Middle East, Africa and Asia. In terms of standard SMS messaging, this as text content can use 140 bytes (octets) per message, which translates to 160 characters (7 bits bytes) of the English alphabet using 7-bit encoding or as few as 70 characters for languages using non-Latin alphabets using UTF-16 encoding. Alternatively, for other forms of text messaging, the commonly cited limit of 140 characters is imposed by some services like Twitter that reserve 20 characters for non-message content, like addressing.

As discussed below, some text messages 109 such as SMS can also be used by applications 110 for the remote controlling of appliances and other applications 110 or devices (e.g. computer peripherals associated with the operating system 108)—see FIG. 1. Further, short codes can be special telephone numbers, shorter than full telephone numbers, that can be used to address SMS and MMS text messages from mobile phones or fixed phones. There are two types of short codes: dialing and messaging.

It is also recognised that notifications 109 can be referred to as electronic messages containing text content as generated as sent by applications 110—see FIG. 1. Electronic text messages can be used to interact with automated systems to, for example, order products or services. Service providers can use direct text messaging mobile phone users about products, payment due dates, etcetera as a form of e-mail. Notifications 109 can have text content involving letters of an alphabet, numerals, as well as special characters, as desired. For example, in a straight and concise definition for the purposes of this English Language article, text messaging by phones or mobile phones could include all 26 letters of the alphabet and 10 numerals, i.e., alpha-numeric messages, or text, to be sent by texter or received by the textee.

The primary display screen/device 112 located on a face (e.g. front face or rear face—also referred to as a back face) of the client device 104 is used to display content 109 as provided by the display module 109 o the display device 112, and optionally as directly (i.e. bypassing the display module 114) to the display device 112 by any of the local application(syservice(s) 110 and/or by any of the hardware devices of the device infrastructure 101 as configured. The bi-stable display screen 112 can be a bi-stable active matrix and high-resolution display screen. The bi-stable display screen 112 can be an E-ink bi-stable display screen. The bi-stable display screen 112 can be Electronic Paper Display under glass. The bi-stable display screen 112 can use interferometric modulation technology.

The device 104 can be a bar form factor display device in which the display screen 112 occupies greater than 70% of the area of the display face of the device case 99 on which the display screen 112 is positioned. The device 104 can be a bar form factor display device in which the display screen 112 occupies greater than 80% of the area of the display face of the device case 99 on which the display screen 112 is positioned. The device 104 can be a bar form factor display device in which the display screen 112 occupies greater than 85% of the area of the display face of the device case 99 on which the display screen 112 is positioned. The device 104 can be a bar form factor display device in which the display screen 112 occupies greater than 90% of the area of the display face of the device case 99 on which the display screen 112 is positioned. The device 104 can be a bar form factor display device in which the display screen 112 occupies greater than 95% of the area of the display face of the device case 99 on which the display screen 112 is positioned. The device 104 can be a bar form factor display device in which the display screen 112 occupies greater than 98% of the area of the display face of the device case 99 on which the display screen 112 is positioned. The device 104 can be embodied as a portable digital assistant, a laptop, a digital audio player (e.g. ipod), or a tablet computer (e.g. ipad). The device 104 can be a bar form factor display device such as a slate device, as a bar or candybar device, as a slab-shaped form. Alternatively, the computer device 104 can be a hinged clam shell design.

In terms of design configuration of the case 99, the case 99 can include a concave front face and a convex rear face, such that the display screen 112 can be positioned on wither the front face or the rear face. Optionally, the magnitudes of curvatures of the front face and the rear face can be the same or similar, the curvature of front and back can be cylindrical, the curvature of front and back can be spherical, the curvature of front and back can be aspherical. Alternatively one or both of the front or rear faces can be flat or planar as compared to curved.

The device 104 can be one in which has a resting position with its front face down which is mechanically stable. The device 104 can be one in which a concave front curvature matches the path of a finger as the user's wrist rotates. The device 104 can be a bar form factor display device 104 in which if the bar form factor display device is placed back down (e.g. convex face down), the bar form factor display device 104 can spin. The device 104 can be a bar form factor display device 104 in which if the bar form factor display device 104 is placed in a leg pocket of a user's clothing with the concave face facing the leg, this can provide better antenna reception than if the convex face faces the leg. The device 104 can be a bar form factor display device 104 in which a curved front face is a vibrating distributed mode loudspeaker (DML) speaker. The device 104 can be a bar form factor display device 104 in which a curved rear face is a vibrating distributed mode loudspeaker (DML) speaker. The device 104 can be a bar form factor display device 112 in which during manufacturing the curved shape is laminated to glass. The device infrastructure 101 can include a camera as one of the hardware devices managed by the operating system 108 and thus applicable to be bypassed when sending the display content 109 to the display module 114.

As example only, the display screen 112 provides approximately at least 1000 full screen updates using 300 mAh of charge, for a screen size of approximately 4 inches. The device 104 can be one including a battery. A battery can hold 300 mAh of charge. The battery can hold a maximum charge in the range of 200 mAh to 400 mAh. The device 104 can have a screen 112 diagonal size of 4 inches. The device 104 can have a screen 112 diagonal size in the range of 3 to 5 inches. The device 104 can be one in which the display screen 112 is operable to provide approximately at least 1,000 full screen updates using a charged battery of the device 104. The device 104 can be one in which the display screen 112 is operable to provide approximately at least 10,000 full screen updates using a charged battery of the device 104. The device 104 can be one in which the display screen 112 is operable to provide approximately at least 100,000 full screen updates using a charged battery of the device 104. The device 104 can be one in which the display screen 112 is operable to update at a rate the order of twice per minute or any other settable update frequency. The device 104 can be one in which the screen 112 does not consume power or require power from the device 104 battery when operated as a bi-stable screen. The device 104 can be one in which the device 112 displays an image 109 when one or more related local applications/services 110 in an off state or in a low power notification mode and thus are bypassed by the operating system 108. The device 104 can be one in which the display screen output 109 provides one or more of: Interactions, Control, Use cases, Personalization, Widgets, Privacy as moderated by the display module 114 and/or the operating system 108.

It is also recognised that the display content 109 (e.g. a notification message) remains on the screen 112 after a step in which the device 104 (e.g. and associated operating system 108) itself is switched off, thus leveraging the ability of the bi-stable screen 112 to maintain the display as a static display without the use of power from the battery of the device 104 until such time as the display content 109 is updated or otherwise changed or replaced. The device 104 can include a virtual keyboard as part of the display content 109 of the display device 112. As such, the display module 114 and/or the operating system 108 can be configured to interpret commands generated by the virtual keyboard due to operator events/interaction with the touch screen ability of the display device 112 and then submit those commands for subsequent interpretation by any of the operating system 108, device infrastructure 101 hardware, and/or local applications/services 110.

In the case where static image content is displayed, various types of EPD screen refresh mechanisms are available to facilitate changing of all or a portion of the display screen, thereby giving the ability of a display module providing display content to the display screen to change (e.g. overwrite) the entire display content at once or to change a selected portion of the display content, i.e. leave some content displayed and change other selected content. The bi-stable screen can be configured to reflect the capabilities of the display module, namely as a matrix display or as a segmented display. Matrix bi-stable displays are intended for applications (e.g. as cooperative with the display module) displaying many different forms of text and/or images. These matrix bi-stable displays comprise an array of pixels, such that these individual pixels are controlled by a thin film transistor (TFT) array. Alternatively, segmented displays are for applications (e.g. as cooperative with the display module) where the display needs can be met using predefined display screen segments that can be turned on or off.

The bi-stable display can be made up of an array of pixels or by a collection of predefined shapes. Once the electronic ink microcapsules have been created, the ink is laminated onto a sheet of plastic film that can be cut into different shapes and sizes as the display screen. These cut parts are then affixed to layer of circuitry coupled to the device infrastructure that can create an electric field across the microcapsule, as manipulated by the display module. It is this electric field that causes the ink to move within the microcapsules and switch from white to black or from colour to colour or from colour to black or from black to colour). For segmented displays, the circuitry (e.g. display driver electronics) coupled (e.g. via connector) to the device infrastructure can be in the shape of the segments that make up the display screen. For Active Matrix displays, the circuitry (e.g. display driver electronics) coupled to the device infrastructure (e.g. via connector) can be a thin film transistor (TFT) array of dots or pixels that allows for very high resolution images and text. As such, the display screen can be integrated into the local client device, such that the display screen as an example includes the display unit having TFT, ink layer, protective sheet, driver electronics and connector, such that the connector is what is used to couple the display unit to the device infrastructure implementing (e.g. executing) the display module in communication with applications/services configured on the device (e.g. local application/service) and/or in communication with applications/services configured off the device (e.g. remote application/service executing on a remote server).

A further computer device 104 example embodiment is where, referring to FIG. 7, the computer device 104 can be configured such that the bi-stable display screen 112 of the computer device 104 is operatively coupled via a data connection 132 (as a wired or wireless connection) for power and/or data transfer with respect to another independent computer device 140, since the case 99 (see FIG. 1) is embodied as a detachable cover 130 having one or more case connectors 134 (e.g. magnets, clips, etc.) configured to attach and hold the cover 130 to a case 136 of the separate computer device 140. It is recognised that the operating system 108 is able to recognize and communicate to the corresponding operating system of the computing device 140 when connected by the connector 132 and vice versa, for example for the purpose of sending the display content 109 from the display module 114 for display on the display 112 and/or to the display (not shown) of the computer device 140.

The following discussion describes notification techniques that can be implemented utilizing the previously described systems and devices. Aspects of each of the procedures can be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the example environment.

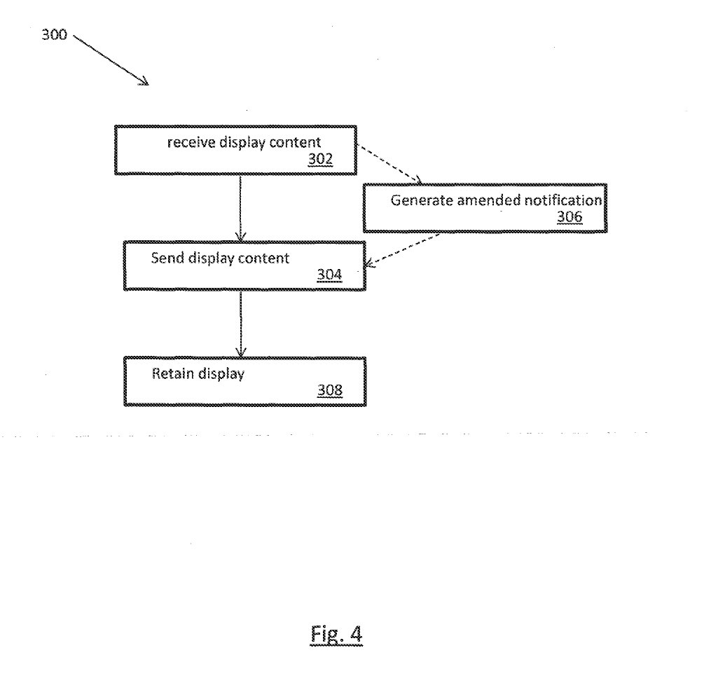

Referring to FIG. 4, illustrated is a method 300 implemented by a computer device (e.g. computer device 104) for displaying display content 109 (e.g. associated with a notification 109). The method comprising at step 302, by the computer device 104 having the bi-stable screen 112 as a one, and only one, screen for displaying display content 109 associated with an application or service 110 executable on the computer device 104 receiving the display content 109 (either locally received and/or obtained from a remote application/service 113) by the display module 114. At step 304 sending the display content 109 for subsequent display on the bi-stable screen 112.

As discussed above, the display content 109 can be a notification message, such that the display content is received from the remote network device 102 via the communications network 106 coupled to the computer device 104. One case is where the computer device is in an off state (e.g. off state pertaining to the application or service in a hibernation mode) when the display content 109 is received by the display module 114 and/or the operating system 108. The off state can be a low power notification mode. In some cases, the display content can be display screen output as operator push output. The display screen output 109 can be obtained from a network service 113 selected from: a social messaging service; a social networking service; a news service; a notification message provider; and/or a news social message service.

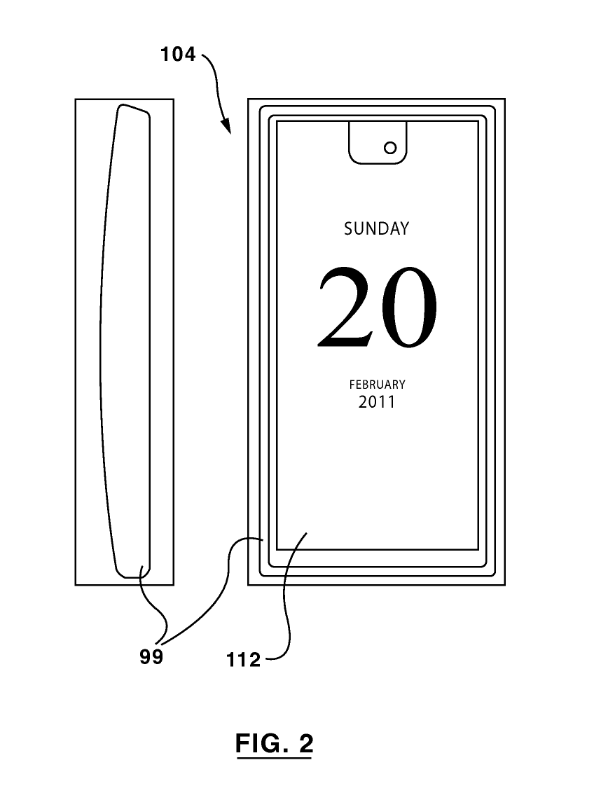

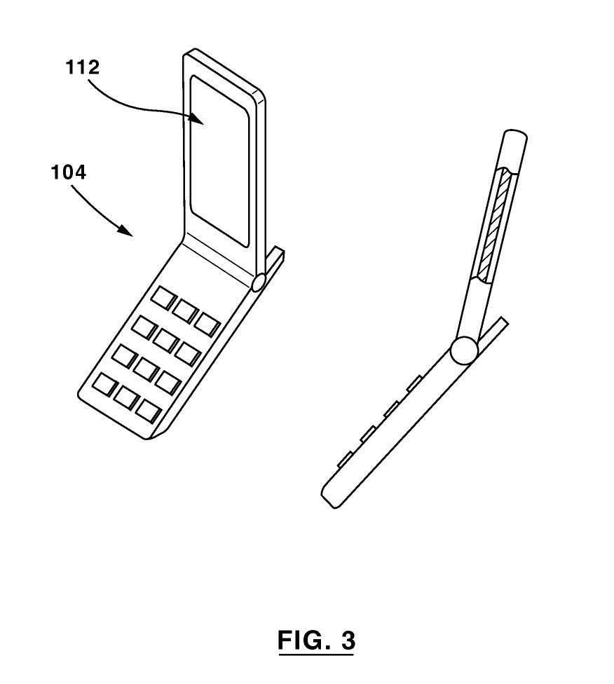

One example is where the computer device 104 is configured as the case 99 having a bar form factor shape with a back face that is curved and a front face that is planar, the front face having the bi-stable screen 112 positioned thereon (see FIG. 2). Referring to FIG. 3, an alternative embodiment of the computer device 104 is a hinge shaped case 99 having a user interface on one side and the display device 112 on the other side of the hinged case 99.

Referring again to FIG. 4, at step 306, preferably deciding to bypass the application or service 110 in the hibernation mode before sending the display content 109 for subsequent display on the bi-stable screen 112, the application or service 110 in the hibernation mode being a target application or service 110 recipient for the display content 109 when the target application or service 110 recipient is in execution mode on a device infrastructure 101 of the computer device 104. At step 308, optionally switching the computer device 104 itself into an off state and retaining the display content 109 displayed on the bi-stable display screen 112. As discussed, the ability to bypass hibernating application/service 110 and/or associated hardware components provides for potential savings in battery power of the computer device 104 that would otherwise be expended in involving operation of those application/service 110 and/or associated hardware components in display of the display content 109 on the display device 112, rather than just using the display capabilities (e.g. identification and/or processing/handling of the display data) display module 114 instead.

As discussed, it is anticipated that one embodiment is where the operating system 108 of the computer device 104 deciding to send the display content 109 to the display module 114 rather than to the application or service 110 being a target application or service 110 recipient for the display content 109 when the target application or service 110 recipient is in execution mode on the device infrastructure 101 of the computer device 104.

It is recognised that the operating system 108 and associated application(s) 110 and display module 114 can be optionally configured to operatively (as implemented by the processor 107) generate the display content 109 for display on the display 112 by the display module 114 in substitution of the application 110 hosted on the computer device 104, the application 110 responsible when in an active state (e.g. running and therefore recognised as an active process by the operating system 108) for processing the display content 109 once received for subsequent display on the display 112. For example, the application 110 can be in an inactive state (e.g. not running and therefore recognised as an inactive process by the operating system 108) for receiving and processing of the display content 109 for display 112 and therefore the display content 109 is instead sent (e.g. by the operating system 108 or otherwise the display module 114 is configured as default to receive the display content 109 once received—for example as a process configured for listening and identifying incoming display content 109 via the onboard bus as generated by local applications 110 and/or for listening and identifying incoming display content 109 via the network interface as generated by remote applications 113) to the display module 114 rather than to the target application 110 for subsequent processing and generation as the display content 109.

Referring to FIG. 1, a computing device 102,104 implementing functionality of the environment 100 can include a network connection interface 105, such as a network interface card or a modem, coupled via connection to a device infrastructure implementing the operating system 108. The connection interface is connectable during operation of the devices to the network 106 (e.g. an intranet and/or an extranet such as the Internet), which enables networked devices to communicate with each other as appropriate. The network 106 can support the communication of the applications 110 provisioned in the environments 108, and the related content 109.

Referring again to FIG. 1, the device 102,104 can also have a user interface including the display 112, coupled to the device infrastructure 101, to interact with a user. The user interface can include one or more user input devices such as but not limited to a QWERTY keyboard, a keypad, a stylus, a mouse, a microphone and the user input/output device such as the screen display 112 and/or a speaker. If the screen 112 is touch sensitive, then the display 112 can also be used as the user input device as controlled by the device infrastructure 101.

Referring again to FIG. 1, operation of the device is facilitated by the device infrastructure 101. The device infrastructure 101 includes one or more computer processors 107 and can include an associated memory 115. The computer processor 107 facilitates performance of the device configured for the intended task (e.g. of the respective module(s) 114) through operation of the network interface 105, the user and other application programs/hardware 110,113 of the device 102,104 by executing task related instructions. These task related instructions can be provided by an operating system 108, and/or software applications located in the memory 115, and/or by operability that is configured into the electronic/digital circuitry of the processor(s) 107 designed to perform the specific task(s). Further, it is recognized that the device infrastructure can include a computer readable storage medium 115 coupled to the processor 107 for providing instructions to the processor 107 and/or to load/update the instructions (e.g. applications 110, display module 114). The computer readable medium 115 can include hardware and/or software such as, by way of example only, magnetic disks and memory cards. In each case, the computer readable medium 115 can take the form of a small disk, hard disk drive, solid-state memory card, or RAM provided in the memory module 115. It should be noted that the above listed example computer readable mediums 115 can be used either alone or in combination.

Further, it is recognized that the computing device 102,104 can include the executable applications comprising code or machine readable instructions for implementing predetermined functions/operations including those of an operating system 108 and the modules 114 and associated applications/services 110 and software configurable aspects of the hardware devices of the device infrastructure 101, for example. The processor 107 as used herein is a configured device and/or set of machine-readable instructions for performing operations as described by example above, including those operations as performed by any or all of the applications/modules 110,114. As used herein, the processor 107 can comprise any one or combination of, hardware, firmware, and/or software. The processor 107 acts upon information by manipulating, analyzing, modifying, converting or transmitting information (e.g. display content 109) for use by an executable procedure (e.g. display module 114) or an information device (display device 112 and/or hardware associated with the configuration of the display module 114), and/or by routing the information with respect to an output device. The processor 107 can use or comprise the capabilities of a controller or microprocessor, for example. Accordingly, any of the functionality of the modules can be implemented in hardware, software or a combination of both. Accordingly, the use of a processor 107 as a device and/or as a set of machine-readable instructions is referred to generically as a processor/module for sake of simplicity.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof, as incorporated by or otherwise executed by the processor 107 of the operating system 108. In the case of a software implementation, the module, functionality, or logic represents program code that performs specified tasks when executed on the processor 107 (e.g., CPU or CPUs). The program code can be stored in one or more computer readable memory devices 115. The features of the techniques described below are platform-independent, meaning that the techniques can be implemented on a variety of commercial computing platforms having a variety of processors.

For example, the computing device 102,104 can also include an entity (e.g., software) that causes hardware of the computing device 102,104 to perform operations, e.g., processors, functional blocks, and so on. For example, the computing device 102,104 can include a computer-readable medium 115 that can be configured to maintain instructions that cause the computing device 102,104, and more particularly hardware (e.g. operating system including hardware and configured and executable instructions) of the computing device 102,104 to perform operations. Thus, the instructions function to configure the hardware to perform the operations and in this way result in transformation of the hardware to perform functions. The instructions can be provided by the computer-readable medium 115 to the computing device through a variety of different configurations.

One such configuration of a computer-readable medium 115 is signal bearing medium and thus is configured to transmit the instructions (e.g., as a carrier wave) to the hardware of the local client device, such as via a network. The computer-readable medium 115 can also be configured as a physical computer-readable storage medium and thus is not a signal bearing medium. Examples of a computer-readable storage medium include a random-access memory (RAM), read-only memory (ROM), an optical disc, flash memory, hard disk memory, and other memory devices that can use magnetic, optical, and other techniques to store instructions and other data.

We claim:

1. A method implemented by a tablet having a bi-stable screen for displaying display content associated with an application or service executable on the tablet, the method comprising:
receiving the display content remotely via a network connection interface; and
sending the display content for subsequent display on the bi-stable screen, the bi-stable screen being the one and only screen of the tablet.

2. The method of claim 1, wherein the display content is a notification message.

3. The method of claim 1 further comprising the step of receiving the display content from a remote network device via a communications network coupled to the tablet.

4. The method of claim 1, wherein the tablet is in an off state.

5. The method of claim 4, wherein the off state pertains to the application or service in a hibernation mode.

6. The method of claim 5, wherein the off state is a low power notification mode.

7. The method of claim 3, wherein the display content is display screen output as operator push output.

8. The method of claim 3, wherein the display screen output is obtained from a network service selected from the group consisting of: a social messaging service; a social networking service; a news service; a notification message provider; and a news social message service.

9. The method of claim 1, wherein the display content is a content update according to one or more categories.

10. The method of claim 9 further comprising the step of selecting the categories.

11. The method of claim 10 further comprising the step of preselecting the categories by a user.

12. The method of claim 1, wherein the tablet has a back face that is curved and a front face that is planar, the front face having the bi-stable screen positioned thereon.

13. The method of claim 1 further comprising the step of determining if the display content is a new display content, and the bi-stable display screen being updated only if the display content is the new display content.

14. The method of claim 1 further comprising the step of switching the tablet itself into an off state and retaining the display content displayed on the bi-stable display screen.

15. The method of claim 1 further comprising the step of implementing privacy control for the display content when displayed on the bistable display screen.

16. The method of claim 4 further comprising the step of deciding to bypass the application or service in the hibernation mode before sending the display content for subsequent display on the bi-stable screen, the application or service in the hibernation mode being a target application or service recipient for the display content when the target application or service recipient is in execution mode on a device infrastructure of the tablet.

17. The method of claim 1 further comprising the step of an operating system of the tablet deciding to send the display content to a display module rather than to the application or service being a target application or service recipient for the display content when the target application or service recipient is in execution mode on a device infrastructure of the tablet.

18. A tablet having a bi-stable screen for displaying display content associated with an application or service executable on the tablet, the tablet comprising software executable on the tablet to cause the tablet to:
receive the display content remotely via a network connection interface; and
send the display content for subsequent display on the bi-stable screen, the bi-stable screen being the one and only screen of the tablet.

19. The tablet of claim 18, wherein the display content is a notification message.

20. The tablet of claim 18 further comprising the software executable on the tablet to cause the tablet to receive the display content from a remote network device via a communications network coupled to the tablet.

21. The tablet of claim 18, wherein the tablet is in an off state.

22. The tablet of claim 21, wherein the off state pertains to the application or service in a hibernation mode.

23. The tablet of claim 22, wherein the off state is a low power notification mode.

24. The tablet of claim 20, wherein the display content is display screen output as operator push output.

25. The tablet of claim 18, wherein the tablet has a back face that is curved and a front face that is planar, the front face having the bistable screen positioned thereon.

26. The tablet of claim 18 further comprising the software executable on the tablet-to cause the tablet to switch the tablet itself into an off state and retain the display content displayed on the bistable display screen.

27. The tablet of claim 20 further comprising the software executable on the tablet to cause the tablet to decide to bypass the application or service in the hibernation mode before sending the display content for subsequent display on the bi-stable display screen, the application or service in the hibernation mode being a target application or service recipient for the display content when the target application or service recipient is in execution mode on a device infrastructure of the tablet.

28. The tablet of claim 18 further comprising the software executable on the tablet-to cause the tablet to decide to send the display content to a display module rather than to the application or service being a target application or service recipient for the display content when the target application or service recipient is in execution mode on a device infrastructure of the tablet.

29. The tablet of claim 28, wherein the display module is a driver for the bi-stable display screen.

30. A method implemented by a tablet having a bi-stable screen for displaying display content associated with an application or service executable on the tablet, the method comprising:
generating the display content by the application or service executing on the tablet; and
sending the display content for subsequent display on the bi-stable screen, the bi-stable screen being the one and only screen of the tablet.
